(19) United States
(12) Patent Application Publication
(10) Pub. No.: US 2014/0379329 A1
(43) Pub. Date: Dec. 25, 2014

(54) METHODS AND APPARATUSES FOR MINING SYNONYMOUS PHRASES, AND FOR SEARCHING RELATED CONTENT

(71) Applicant: Alibaba Group Holding Limited, Grand Cayman (KY)

(72) Inventors: Xinghua Dong, Hangzhou (CN); Kewen Wu, Hangzhou (CN); Peng Huang, Hangzhou (CN); Feng Lin, Hangzhou (CN)

(21) Appl. No.: 14/311,079

(22) Filed: Jun. 20, 2014

(30) Foreign Application Priority Data
Jun. 24, 2013 (CN) 201310253731.2

(51) Int. Cl. G06F 17/27

(52) U.S. Cl. CPC G06F 17/2775; G06F 17/275
USPC 704/9

(57) ABSTRACT

The present disclosure is related to a method and an apparatus of mining synonymous phrases. The method comprises: obtaining, according to a parallel text corpus, a first phrase-alignment relationship from phrases of a current language to phrases of an intermediate language, and a second phrase-alignment relationship from the phrases of the intermediate language to the phrases of the current language; obtaining, for a target phrase of current language, a first set of aligned phrases of the intermediate language that are aligned with the target phrase of the current language based on the first phrase-alignment relationship; obtaining a second set of aligned phrases of the current language that are aligned with selected phrase(s) in the first set of aligned phrases based on the second phrase-alignment relationship; and obtaining synonymous phrases for the target phrase from the second set of aligned phrases.

### CROSS REFERENCE TO RELATED PATENT APPLICATION

This application claims foreign priority to Chinese Patent Application No. 201310253731.2 filed on Jun. 24, 2013, entitled “Method and Apparatus of Mining Synonymous Phrases, and Method and Apparatus of Searching Related Content”, which is hereby incorporated by reference in its entirety.

### TECHNICAL FIELD

The present disclosure relates to the field of data processing, and more particularly, to methods and apparatuses of mining synonymous phrases, and methods and apparatuses of searching related content based on a search request.

### BACKGROUND

Most existing search engines still generally employ a strategy of simple string matching, and fail to fully understand the meaning of a phrase and the intent of a user. Specifically, a search engine first performs a word structure analysis for a word or a phrase entered by a user to determine a search keyword. From the viewpoint of a user, the goal of a search is to obtain content that he/she desires. Performing the search based on a keyword provided by the user is not the sole criterion to determine whether this goal is fulfilled. This is because: first, a user may not know a correct search keyword or the selection of a keyword may not be accurate; second, for an information source to be searched, information that the user desires may exist but may not include the keyword submitted by the user. For example, if a user uses the word “racket” as a keyword to search for related content and a database to be searched only contains the word “racquet,” the user would not obtain corresponding information due to a keyword mismatch, thus failing to obtain desired search results.

Indeed, a good algorithm of searching for a match or a search engine needs to find desired information for a user regardless of whether he/she has provided a clear and comprehensive keyword. Therefore, how to supplement an existing and relatively mature search algorithm that is based on string matching with a semantic search becomes a key for solving this problem. Meanwhile, searching using replaced synonyms is a very important strategy for the semantic search. How to find a large number of accurate synonyms has become an active research area in the field of data mining nowadays.

Existing techniques of mining synonyms can be classified into two types:

The first type is a mining method based on existing knowledge bases, e.g., mining synonyms from semantic dictionaries, such as hownet, wordnet, Cilin, etc. Since these types of knowledge bases are created by linguists using rules, this type of method is limited in scale, accuracy, type of language and application scenario.

The second type is a mining method based on searching and clicking behaviors of users. For a search list generated by a search engine for a same query term, users may click on different search result items. Similarities that exist among these different search items are taken as a basis for synonym mining. However, the following deficiencies exist for synonyms that are mined based on this concept: (1) the number of synonyms that are to be mined is very limited if a search engine cannot return search result items having a semantic relationship; (2) noise associated with synonyms that are mined via this method is very large if a query is a broad term. For example, if a keyword searched by a user is “furniture”, search results such as “table”, “chair”, “sofa,” etc. may appear, which do not have a same or similar meaning.

As such, a new method for mining synonyms is needed to overcome the above deficiencies.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

Accordingly, an objective of the present disclosure is to provide a method of mining synonyms in order to facilitate the finding of a large number of accurate synonyms.

According to an embodiment of the present disclosure, a computer-implemented method of mining synonymous phrases is provided, which includes: (a) obtaining, according to a parallel text corpus, a first phrase-alignment relationship from phrases of a current language to phrases of an intermediate language and a second phrase-alignment relationship from the phrases of the intermediate language to the phrases of the current language; (b) for a target phrase of the current language, obtaining a first set of aligned phrases of the intermediate language that are aligned with the target phrase based on the first phrase-alignment relationship; (c) obtaining a second set of aligned phrases of the current language that are aligned with selected phrase(s) in the first set of aligned phrases based on the second phrase-alignment relationship; and (d) obtaining synonymous phrases for the target phrase from the second set of aligned phrases.

According to an embodiment of the present disclosure, a computer-implemented apparatus of mining synonymous phrases is further provided, which includes: an alignment relationship acquisition module used for obtaining, according to a parallel text corpus, a first phrase-alignment relationship from phrases of a current language to phrases of an intermediate language and a second phrase-alignment relationship from the phrases of the intermediate language to the phrases of the current language; a first set acquisition module used for, for a target phrase of the current language, obtaining a first set of aligned phrases of the intermediate language that are aligned with the target phrase based on the first phrase-alignment relationship; a second set acquisition module used for obtaining a second set of aligned phrases of the current language that are aligned with selected phrase(s) in the first set of aligned phrases based on the second phrase-alignment relationship; and a synonymous phrase acquisition module used for obtaining synonymous phrases for the target phrase from the second set of aligned phrases.

According to another embodiment of the present disclosure, a method of searching related content based on a search request is provided, which includes: determining a search keyword based on a search request; obtaining a synonymous phrase for the search keyword based on the above method of mining synonymous phrases; and searching and displaying related content based on the search keyword and the synonymous phrase of the search keywords.

According to another embodiment of the present disclosure, an apparatus of searching related content according to a search request is provided, which includes: a search keyword determination module used for determining a search keyword based on a search request; a synonymous phrase mining module used for obtaining a synonymous phrase for the search keyword based on the above method of mining synonymous phrases; and a search and display module used for searching and displaying related content based on the search keyword and the synonymous phrase of the search keywords.

Compared with existing technologies, the technique of mining synonymous phrases in the present disclosure computes a phrase translation table (which is similar to a translation dictionary, i.e., a phrase translation/alignment relationship between two languages) from a massive amount of parallel text corpora that are obtained through network mining, manual collection and proofreading, etc., via a machine learning method, and mines synonymous phrases based on the phrase translation table and degrees of semantic similarity. The disclosed method finds a first phrase-alignment relationship from a current language to an intermediate language using a parallel text corpus, and finds a second phrase-alignment relationship from the intermediate language to the current language using the parallel text corpus. A large number of accurate synonymous phrases can be obtained simply through a few simple queries. This leads to a very fast processing speed when a computer performs the mining of synonymous phrases, thus resulting in a very high efficiency of mining the synonymous phrases.

In addition, the disclosed scheme of searching for related content based on a search request can expand a search scope according to a need of a user, improve the possibility and the comprehensiveness of covering the content desired by the user, and enhance search performance by obtaining a large number of accurate synonymous phrases for a search keyword and searching for all related content of these synonymous phrases. Therefore, information that the user desires to find is returned to him/her to facilitate the usage thereof by the user.

### BRIEF DESCRIPTION OF THE DRAWINGS

The drawings described herein are used to provide a further understanding of the present disclosure, and are constituted as parts of the present disclosure. Exemplary embodiments of the present disclosure and descriptions thereof are used for explaining the present disclosure, and should not be construed as limitations of the present disclosure. In the drawings:

FIG. 1 is a flowchart illustrating an example computer-implemented method of mining synonymous phrases.

FIG. 2 is a schematic diagram illustrating an example word-alignment relationship.

FIG. 3 is a schematic diagram illustrating an example phrase extraction.

FIG. 4 is a flowchart illustrating an example method of searching related content based on a search request of a user.

FIG. 5 is a structural diagram illustrating an example computer-implemented apparatus of mining synonymous phrases.

FIG. 6 is a structural diagram illustrating an example apparatus of searching related content based on a search request of a user.

FIG. 7 is a structural diagram illustrating the example apparatus as described in FIG. 5.

FIG. 8 is a structural diagram illustrating the example apparatus as described in FIG. 6.

### DETAILED DESCRIPTION

As mentioned above, the inventors of the present disclosure have noted that the methods of mining synonyms based on semantic dictionaries such as hownet, wordnet and Cilin are limited in scale, accuracy, type of language, and application scenario. The method of employing similarities that exist among different search items clicked by users as a basis for mining synonyms needs a search engine to return search results having a semantic relationship. Otherwise, the number of synonyms that can be mined is very limited. Furthermore, noise associated with the synonyms that are mined via this method is relatively large.

Accordingly, a concept of the present disclosure is to include the advantages of the above two methods in a single body. By means of a machine learning method, a phrase translation table (which is similar to a translation dictionary, i.e., a phrase translation/alignment relationship between two languages) is computed from a massive amount of parallel text corpora that are obtained through network mining, manual collection and proofreading, etc., and synonymous phrases are mined based on the phrase translation table and degrees of semantic similarity. The parallel text corpora may come from the Internet, open source parallel text corpora, archives, etc., and may be dynamically expanded or adjusted, with the sources thereof belonging to a variety of different fields, scenarios or languages. Therefore, the parallel text corpora do not suffer from limitations of dictionaries created from the knowledge of linguists and limitations of scenarios and language. Moreover, when the parallel text corpora are expanded continuously, the number of synonyms that can be obtained is increased continuously. In addition, because the synonyms are mined based on a translation relationship between phrases and according to degrees of semantic similarity, the accuracy of the synonyms mined is guaranteed and the noise is reduced. In short, the disclosed method can obtain a large number of accurate synonyms without limitations of the knowledge of linguists, scenarios, fields and languages.

In order to make the objectives, technical solutions and advantages of the present disclosure more clear, the present disclosure is described hereinafter in further detail below and in the accompanying drawings.

First, in order to facilitate description and understanding, terminologies used in the present disclosure are explained below:

Phrase: A phrase in the present disclosure may refer to as a single word or a combination of multiple consecutive words, e.g., “I”, “keep”, “keep contact with”.

Synonymous phrases: Synonymous phrases in the present disclosure refer to phrases having a same or similar meaning. The term “phrase” described in this clause refers to the term “phrase” described in the previous clause.

Current language: refers to a language currently used by the user, including the language of the words entered by the user and the language of the obtained words that is outputted. The current language is expressed as an acronym “language A” in the embodiments for simplicity.

Intermediate language: refers to a language different from the current language, which is used in the algorithm of the method of the present disclosure for obtaining the current language synonyms. The intermediate language is expressed as an acronym “language B” in the embodiments for simplicity.

Parallel text corpus: refers to a translation text corpus obtained through various ways such as network mining, manually collection and proofreading. In the statistics of translation, a parallel text corpus normally consists of a massive amount of parallel sentence pairs that are respectively stored in two separate text documents in which each parallel sentence pair includes two sentences (or two phrases or two words). One is expressed in language A, and the other is expressed in language B. These two sentences are semantically the same, wherein their corresponding lines in the text documents are the translation for each other.

Phrase-alignment relationship: refers to a phrase translation relationship or a phrase translation table, which indicates as aligning/translation relationship for phrases in any two kinds of languages. Specifically, when a phrase of language A and a phrase of language B are aligned with each other in one parallel sentence pair, the phrase of language A and the phrase of language B are deemed as having an aligning/translation relationship. With respect to one phrase of language A, when there are one or more phrases of language B having an aligning/translation relationship with the phrase of language A, it is determined that the phrase of language A and the one or more phrases of language B form a phrase-aligning relationship.

Alignment probability: the probability, that one phrase of language B aligns with the phrase of language A with respect to all parallel sentence pairs that include the phrase of language A in a parallel text corpus, is referred to as an alignment probability for the phrase of language B.

Target phrase: refers to a phrase for which synonymous phrases are obtained in the present disclosure.

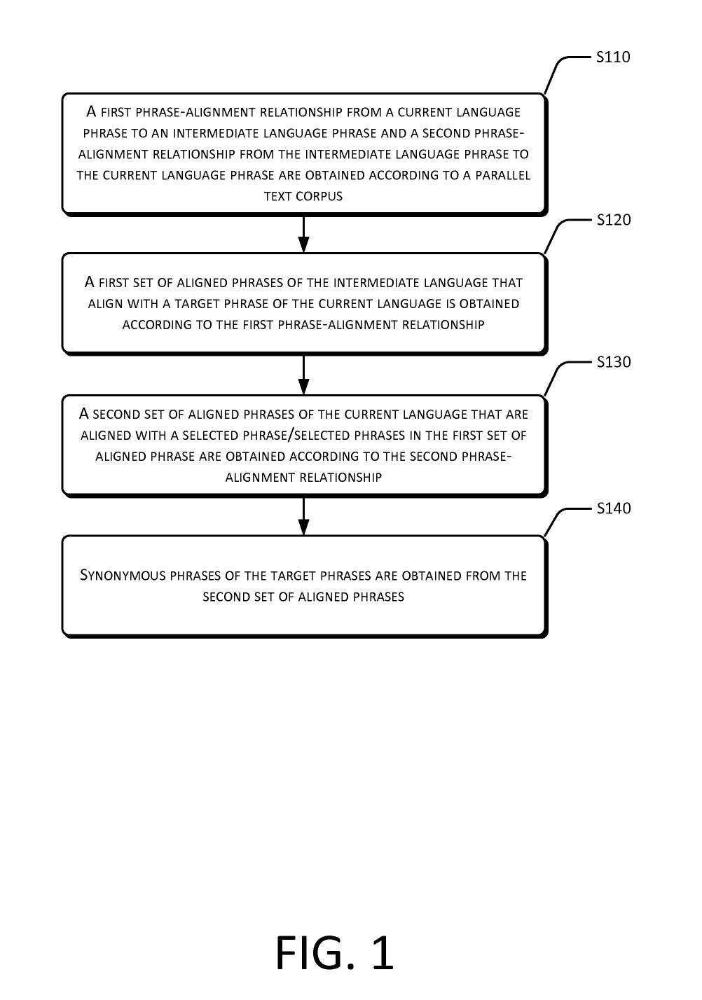

Referring to FIG. 1, which is a flowchart illustrating a computer-implemented method for mining synonymous phrases according to one embodiment of the present disclosure. The method includes blocks S110-S140.

At block S110, a first phrase-alignment relationship from a current language (language A) phrase to an intermediate language (language B) phrase and a second phrase-alignment relationship from the intermediate language phrase to the current language phrase are obtained according to a parallel text corpus.

As mentioned above, a parallel text corpus is normally composed of a massive amount of parallel sentences pairs and each parallel sentence pair includes two sentences (or two phrases or two words). One is expressed in language A, and another is expressed in language B. These two sentences have the same meaning. Furthermore, the pair of parallel sentences may come from various kinds of archived data. For example, some websites are built in two languages, in which corresponding words, phrases and sentences may be extracted to be used as parallel sentence pairs. Some websites provide articles in two languages in which corresponding sentences may be extracted to be used as parallel sentence pairs. Some example sentences in various dictionaries may also be used as parallel sentence pairs. The open source parallel text corpora can also be utilized as well. Therefore, the parallel text corpus is able to be expanded or adjusted dynamically, and is not limited by domains, scenarios or languages.

According to an embodiment of the present disclosure, a word-alignment relationship between a current language word and an intermediate language word in each parallel sentence pair of the parallel text corpus may be obtained, and then a first phrase-alignment relationship between a current language phrase and an intermediate language phrase and a second phrase-alignment relationship between the intermediate language phrase and the current language phrase are obtained according to the word-alignment relationship.

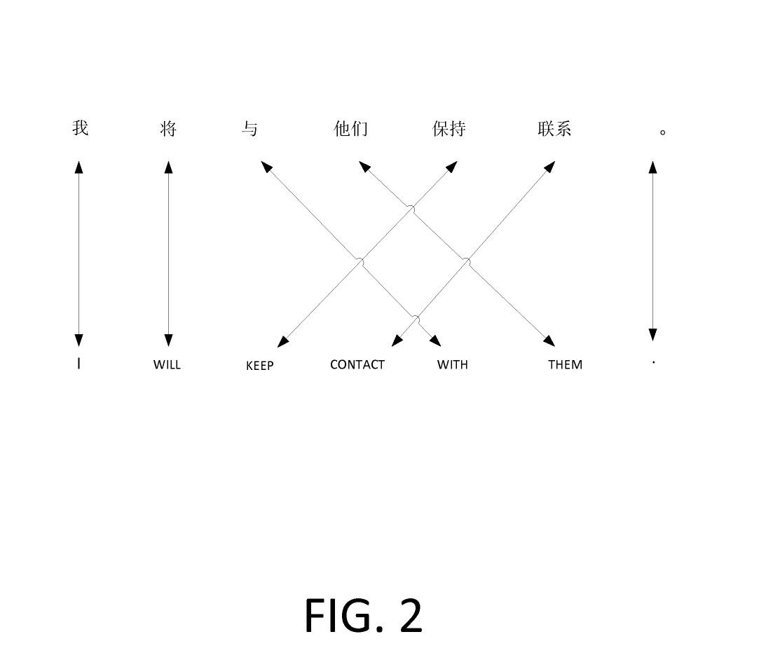

Specifically, the word-alignment relationship in the parallel sentence pair may be obtained by means of a known word-alignment algorithm in the art. As shown in FIG. 2, an example of the word-alignment algorithms can be referenced in The Mathematics of Statistical Machine Translation Parameter Estimation, which was published in 1993 by Peter F. Brown, Stephen A. Della Pietra, Vincent J. Della Pietra, and Robert L. Mercer; Computational Linguistics; 19(2):263-311.

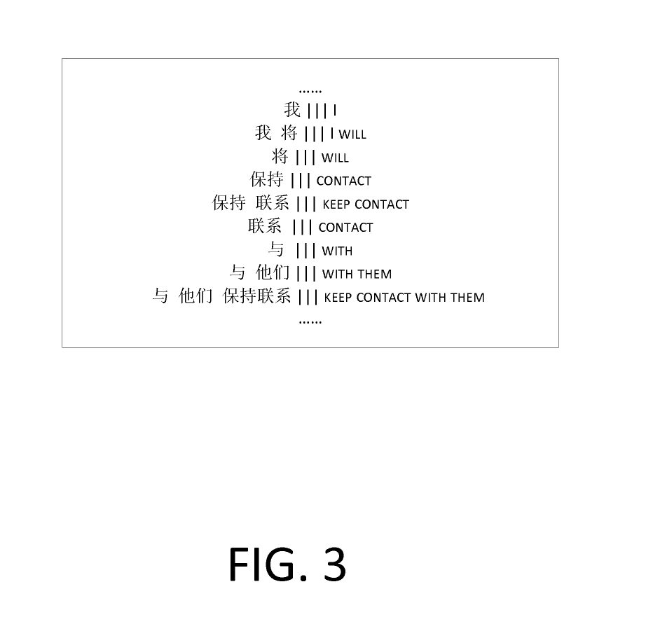

Thereafter, phrase pairs may be extracted from the phrase-alignment relationship in various parallel sentence pairs in accordance with the phrase extraction algorithm known in the field. For example, one or more adjacent words in the language A's sentence of the sentence pair may be extracted to form a language A's phrase, and a language B's phrase may be formed by means of extracting corresponding aligned words from the language B's sentence that aligns with the language A's sentence, by which the extracted language A's phrase and the extracted language B's phrase form an aligned phrase pair. FIG. 3 shows a schematic diagram of the process of extracting phrase pair under a condition that words are aligned as shown in FIG. 2. The dissertation of Franz Josef Och, Statistical machine translation: From single-word models to alignment templates, can be referenced for the phrase extraction algorithm. In a similar way, all possible aligned phrase pairs from one parallel sentence pair may be extracted, and phrase pairs may be extracted from all parallel sentence pairs in the parallel text corpus similarly, thereby obtaining a large number of phrase pairs.

Next, all intermediate language phrases that are aligned with the current language phrases may be calculated with respect to the current language phrases in each phrase pair based on the extracted phrase pairs, thereby forming a first phrase-alignment relationship from the current language phrases to the intermediate language phrases. Furthermore, in the parallel text corpus, a probability of each intermediate language phrase aligning with the current language phrase in all parallel sentence pairs that include current language phrases can be calculated. The calculated probability will be referred herein as the first alignment probability, which can be considered as being included in the first phrase-aligning relationship. The first phrase-alignment relationship may also be referred to as “the first phrase translation probability list.” The degrees of semantic similarity between corresponding phrases in the first phrase-alignment relationship may be represented by the first phrase translation probability.

Similarly, by means of a reverse training, all current language phrases that are aligned with the intermediate language phrase may be calculated with respect to the intermediate language phrase in each phrase pair based on the aligned phrase pairs, and thereby a second-alignment relationship from the intermediate language phrases to the intermediate language phrases is formed. Further, in the parallel text corpus, a probability of each current language phrase aligning the intermediate language phrase in all parallel sentence pairs that include intermediate language phrases can be calculated. The calculated probability will be referred herein as the second alignment probability, which can be considered as being included in the second phrase-alignment relationship. The second phrase-alignment relationship may also be referred to as “the second phrase translation probability list.” The degrees of semantic similarity between corresponding phrases in the second phrase-alignment relationship may be represented by the second phrase translation probability.

In the above embodiment, the first phrase-alignment relationship and the second phrase-alignment relationship are calculated from a massive amount of phrase pairs that are extracted according to the word-alignment relationship in the various parallel sentence pairs in the parallel text corpus, but the present disclosure is not limited thereto. Any appropriate method in the art which is previously known or yet to be developed may be implemented for obtaining the first phrase-alignment relationship and the second phrase-alignment relationship.

For example, with respect to the phrase “lamp” of the language A, a first phrase-alignment relationship related to the phrase may be obtained according to the above statistical analysis, as shown in table 1:

TABLE 1

| language A | | First alignment |
|---|---|---|
| phrase | language B phrase | probability |
| lamp | [symbol] (light) | 0.4 |
| | [symbol] (light bulb) | 0.1 |
| | [symbol] (electric light) | 0.4 |
| | [symbol] (fluorescent | 0.1 |
| | tube) | |

For example, with respect to the Chinese phrases “ [symbol] (light),” [symbol] (light bulb),” “ [symbol] (electric light)” and “ [symbol] (fluorescent tube),” a second phrase-alignment relationships with their corresponding English phrases may be obtained by means of similar reverse training, as shown in table 2:

TABLE 2

| | | Second alignment |
|---|---|---|
| language B phrase | language A phrase | probability |
| [symbol] (light) | light | 0.4 |
| | lamp | 0.4 |
| | lights | 0.1 |
| | lamps | 0.1 |
| [symbol] (light bulb) | bulb | 0.4 |
| | bulbs | 0.1 |
| | light bulb | 0.4 |
| | light bulbs | 0.1 |
| [symbol] (electric light) | electric light | 0.5 |
| | led lamp | 0.5 |
| [symbol] (fluorescent tube) | light | 0.2 |
| | led light | 0.8 |

Although there is only one phrase of language A shown in the first phrase-alignment relationship in the above example and there are only four phrases of language B shown in the second phrase-alignment relationship, it should be noted that a person of ordinary skill in the art should understand that a massive amount of such phrase-alignment relationships may be included in the first phrase-alignment relationship or the second phrase-alignment relationship to facilitate subsequent comprehensive search of keywords, and are not limited to these specific numbers.

Next, at block S120, a first set of aligned phrases of the language B that align with a target phrase of the language A is obtained according to the first phrase-alignment relationship.

Specifically, when synonymous phrases of a specific phrase in language A are to be obtained, that phrase in language A is taken as the target phrase of the language A. With respect to the target phrase in language A, all phrases in the language B that are aligned with the target phrase in language A are obtained from the first phrase-alignment relationship that corresponds to the target phrase in language A as obtained from block S110. In an exemplary embodiment, with respect to the English target phrase “lamp”, a first set of aligned phrases in Chinese, e.g. [symbol] (light), [symbol] (light bulb), [symbol] (electric light), [symbol] (fluorescent tube) that are aligned with “lamp” can be found from the table 1.

In an embodiment, the intermediate language phrases that are aligned with the target phrase of the current language may be selected according to a degree of semantic similarity between each language B phrase and the target phrase in language A in the first phrase-alignment relationship to form a first set of aligned phrases. In this embodiment, the accuracy of the final synonymous phrase may be ensured, and computational workload in subsequent blocks may be reduced too.

Specifically, according to the aforementioned first alignment probability, the intermediate language phrases with a higher first alignment probability may be selected to form a first set of aligned phrases for further usage. In one specific embodiment, the first set of aligned phrases may be formed by selecting the top N intermediate language phrases in an ascending order based on respective first alignment probabilities. In an alternative embodiment, the intermediate language phrases with a first alignment probability that exceeds a threshold may be selected to form the first set of aligned phrases. For example, in the above exemplary embodiment, with respect to the English target phrase “lamp”, a first set of aligned phrases containing phrases “ [symbol] (light)” and “ [symbol] (electric light)” can be found from table 1 according to whether the phrases in the table 1 has an alignment probability exceeds 0.2.

In the embodiments of the present disclosure, the degree of semantic similarity is represented by the alignment probability, but the present disclosure is not limited thereto. Any appropriate method in the art which is previously known or yet to be developed may be used to represent the degree of semantic similarity between corresponding phrases.

Next, at block S130, a second set of aligned phrases of language A that are aligned with a selected phrase/selected phrases in the first set of aligned phrase are obtained according to the second phrase-alignment relationship.

Specifically, after the first set of aligned phrases is obtained, all phrases in language A that are aligned with one or more selected phrases in the first set of aligned phrases may be found from the second phrase-alignment relationship to form a second set of aligned phrases. For example, in the above exemplary embodiment, with respect to the first set of aligned phrases “ [symbol] (light),” “ [symbol] (light bulb),” “ [symbol] (electric light),” “ [symbol] (fluorescent tube)”, English phrases that are respectively aligned with one or more phrases in the first set of aligned phrases may be found from the second phrase-alignment relationship as shown in table 2 to from a second set of aligned phrases, which includes: light, lamp, lights, lamps, bulb, bulbs, light bulb, light bulbs, electric light, led lamp, light and led light. In this embodiment, the English phrases that are respectively aligned with each phrase in the second set of aligned phrases are retrieved.

In an embodiment, the language A phrases that are semantically similar and are aligned with the selected phrases in the first set of aligned phrases may be selected according to a degree of semantic similarity between each language A phrase in the second phrase-alignment relationship and the selected language B phrase in the first set of aligned phrases to form a second set of aligned phrases. Through this embodiment, the accuracy of the final synonymous phrase may be ensured, and the computational workload in subsequent blocks may be reduced too.

Specifically, similar to the aforementioned method, the language A phrases that have a relatively higher second alignment probability may be selected according to respective second alignment probabilities to form a second set of aligned phrases. In one specific embodiment, the second set of aligned phrases may be formed by selecting the top N language A phrases in an ascending order based on respective second alignment probabilities. In an alternative embodiment, the language A phrases with a second alignment probability that exceeds a threshold may be selected to form the second set of aligned phrases. For example, in the above exemplary embodiment, with respect to the first set of aligned phrases containing phrases, ““ [symbol] [symbol] (light bulb),” “ [symbol] (electric light),” “ [symbol] (fluorescent tube)”, a second set of aligned phrases are found from table 2 according to whether the phrases has an alignment probability exceeds 0.2. In this embodiment the second set of aligned phrases includes: light, lamp, lights, lamps, bulb, bulbs, light bulb, light bulbs, electric light, LED lamp, light and LED light.

Similarly, in the embodiments of the present disclosure, the degree of semantic similarity is represented by the alignment probability, but the present disclosure is not intended to be limited thereto. Any appropriate method in the art which is previously known or yet to be developed may be used to represent the degree of semantic similarity between corresponding phrases.

Next, at block S140, synonymous phrases of the target phrases are obtained from the second set of aligned phrases.

In an embodiment, after the second set of aligned phrases is obtained at block S130, all phrases in the second set of aligned phrases may be taken as synonymous phrases of the target phrase.

In another embodiment, the synonymous phrases of the target phrase may be selected according to a degree of semantic similarity between each phrase in the second set of the aligned phrases and the target phrase.

Specifically, by means of a method similar to the above which uses the alignment probability to represent the degree of semantic similarity, the degree of semantic similarity between each phrase in the second set of the aligned phrases and the target phrase may be determined based on a first alignment probability of the first phrase-alignment relationship that is from the language A phrases to the language B phrases, and a second alignment probability of the second phrase-alignment relationship that is from the language B phrases to the language A phrases. In one embodiment, the degree of semantic similarity between each phrase in the second set of aligned phrases and the target phrase may be represented by a product of the associated first alignment probability and the associated second alignment probability.

For example, in the above exemplary embodiment, the degree of semantic similarity between “lamp” and “light” is as follows:

Lamp [symbol] (light)→light 0.16 (0.4×0.4)+lamp→ [symbol] (fluorescent tube)→light 0.02(0.2×0.1)=0.18.

The degree of semantic similarity between “lamp” and “bulbs” is: lamp→ [symbol] (light bulb)→bulbs 0.01 (0.1×0.1).

In an embodiment, the phrases in the second set of aligned phrases may be sorted in an ascending order in accordance with the calculated degrees of semantic similarity, in which the top N phrases may be selected as the synonymous phrases of the target phrase.

In another embodiment, the phrases with a degree of semantic similarity greater than a predetermined threshold value may be selected as the synonymous phrases of the target phrase.

In the above embodiment, the degree of semantic similarity between the target phrase and each phrase in the second set of aligned phrases is represented by the product of the first alignment probability and the second alignment probability, but the present disclosure is not intend to be limited thereto. The degree of semantic similarity may be represented by other appropriate ways.

The method for mining the synonymous phrases according to the embodiments of the present disclosure has been described above. According to the computer-implemented method for mining synonymous phrases provided by the present disclosure, a list of phrase translation probabilities may be obtained from an enormous amount of parallel text corpora, and the synonymous phrases of the target phrase that are semantically similar may be found based on the list of phrase translation probabilities to obtain a large amount of accurate synonymous phrases without being limited by the knowledge of linguist, scenario, domain and language. In addition, according to the embodiment of the present disclosure, a first phrase-alignment relationship from the current language to the intermediate language is found using the parallel text corpus, and a second phrase-alignment relationship from the intermediate language to the current language is found using the parallel text corpus. The mining technique of the present disclosure only needs a few simple inquiries to obtain massive and accurate synonymous phrases in a very fast processing speed when a computer performs synonymous phrase mining, and so it is with a very high efficiency.

According to another embodiment of the present disclosure, after the synonymous phrases of the target phrase are obtained by means of above method with reference to FIG. 1, one or more phrases of the synonymous phrases may further be taken as the target phrase/phrases for obtaining more synonymous phrases thereof, by repeating the above blocks as illustrated in FIG. 1 in order to expand the coverage of the synonymous phrases, and then the synonymous phrases and synonymous phrases of one or more phrases of the synonymous phrases may be taken together as the synonymous phrases of the target phrases. Such process may be repeated several times according to different application demands. In one embodiment, the process may be repeated 2-3 times. The mining method according to this embodiment is able to further expand the coverage of the synonymous phrases as compared to the above method described with reference to FIG. 1.

In the above method of mining synonymous phrases, the synonymous phrases obtained may include disabled words, words with punctuation marks or overlapped words. Therefore, according to another embodiment of the present disclosure, after the synonymous phrases of the target phrase (i.e., the synonymous phrases of the target phrase and/or the synonymous phrases of each synonymous phrase) are obtained by the above method, a filtering process may be applied to the synonymous phrases of the target phrase according to predetermined rules for obtaining more accurate synonymous phrases.

Specifically, the predetermined rules may include at least one of the following:

determining whether the synonymous phrases include a word in a disabled words list;

determining whether the synonymous phrases include a word in a prohibited words list;

determining whether the synonymous phrases include a punctuation mark;

determining whether there is a covering relationship between the synonymous phrase and the target phrase; and

determining whether any of two phrases in the synonymous phrases are identical after extracting their roots.

In other words, the synonymous phrases of the target phrases may be filtered in accordance with one or more of the above predetermined rules. Accordingly, the filtering process may include one or more of the following steps:

removing the synonymous phrase when it is determined as including words in a list of disabled words, or otherwise keeping the synonymous phrase;

removing the synonymous phrase when it is determined as including words in a list of prohibited words, or otherwise keeping the synonymous phrase;

removing the synonymous phrase when it is determined as including a punctuation mark, or otherwise keeping the synonymous phrase;

removing the synonymous phrase when it is determined that there is a covering relationship between the synonymous phrase and the target phrase, or otherwise keeping the synonymous phrase; and

removing one of the two synonymous phrases that are identical after their roots are extracted, and keeping the other one.

It should be noted that the predetermined rules are not limited to the specific examples listed in the above embodiment, and the present disclosure is not intended to be limited thereto. Any appropriate rules may be adopted.

In comparison to the aforementioned embodiments, the method for mining the synonymous phrases according to this embodiment is able to filter out unnecessary synonymous phrases, thereby obtaining a set of more accurate synonymous phrases.

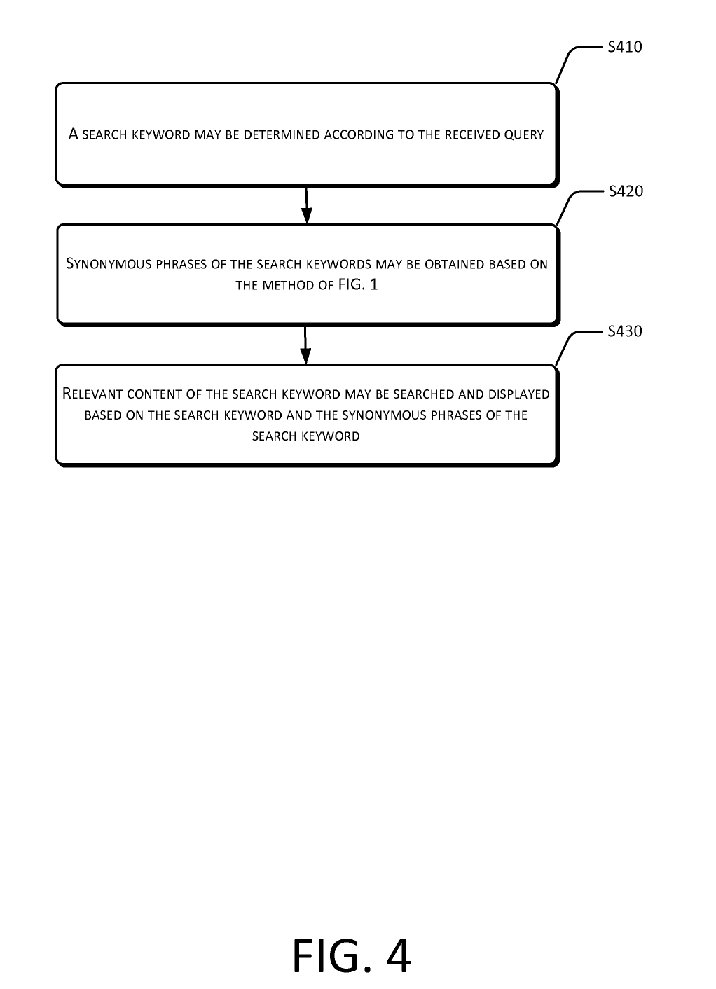

The computer-implemented method for mining synonymous phrases according to above embodiments of the present disclosure may be implemented in various suitable scenarios. The implementation of the present disclosure in the field of the search engine is described as follows with reference to the FIG. 4.

Referring to FIG. 4, a flowchart illustrating a method for searching relevant content in connection to a query of a user according to one embodiment of the present disclosure is shown.

As shown in FIG. 4, at block S410, a search keyword may be determined according to the received query.

Specifically, the search engine may receive an inquiry from any client, which may include any content that the client wants to search, such as a word or a phrase entered by the user.

Then, the search engine performs a word structure analysis with respect to the word or the phrase entered by the user to determine search keywords. The word structure analysis may be accomplished by known technologies in the art and the detail is omitted so as not to obscure the present disclosure.

Next, at block S420, synonymous phrases of the search keywords may be obtained based on the aforementioned computer-implemented method for mining synonymous phrases.

The specific process of this block may be obtained by referring to the process of the method for mining synonymous phrases according to above embodiments of the present disclosure and the detail will be omitted here for simplicity.

Consequently, at block S430, relevant content of the search keyword may be searched and displayed according to the search keyword determined at block S410 and the synonymous phrases of the search keyword that are obtained at block S420.

According to an embodiment of the present disclosure, the method for searching relevant content according to an inquiry request is by means of obtaining a massive amount of accurate synonymous phrases for the search keyword, and searching all the relevant content of these synonymous phrases accordingly, so that it is able to expand search coverage with respect to the user's needs, and increase the likelihood and comprehensiveness of coverage in terms of the user's desired content. The search performance is therefore enhanced, so that it is thus capable of providing the user with the information that he/she wishes to retrieve and facilitating user utilization.

Similar to the computer-implemented method for mining synonymous phrases and the method for searching the relevant content according to the inquiry, there is provided with corresponding apparatus of mining synonymous phrases and apparatus of searching the relevant content according to the inquiry respectively according to the embodiments of the present disclosure.

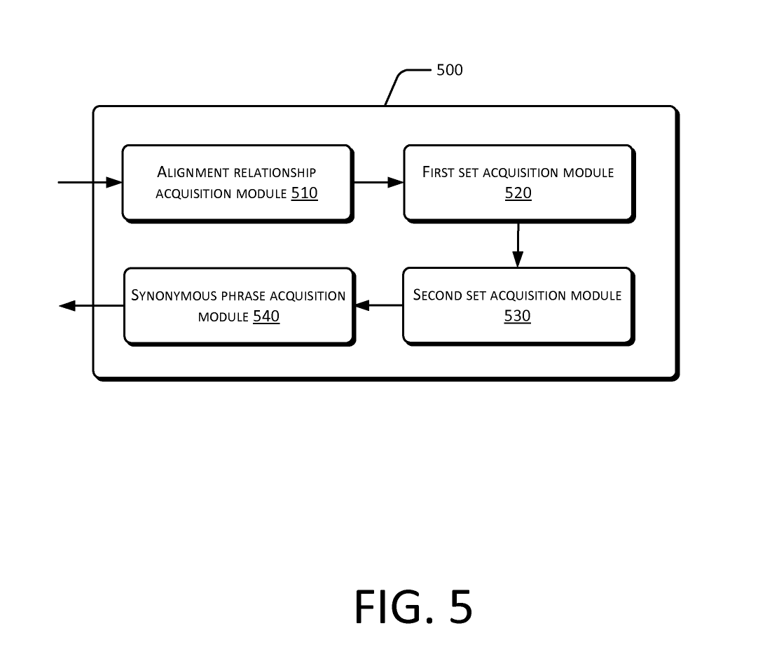

Refer to FIG. 5, a block diagram illustrating a computer-implemented apparatus 500 for mining synonymous phrases according to one embodiment of the present disclosure is shown.

As shown in FIG. 5, the apparatus 500 may include an alignment relationship acquisition module 510, a first set acquisition module 520, a second set acquisition module 530 and a synonymous phrase acquisition module 540.

Specifically, an alignment relationship obtaining module 510 may be utilized for obtaining a first phrase-alignment relationship from a current language phrase to an intermediate language phrase and a second phrase-alignment relationship from the intermediate language phrase to the current language phrase according to a parallel text corpus. A first set acquisition module 520 may be utilized for obtaining a first set of aligned phrases of the intermediate language phrases that align with a target phrase of the current language according to the first phrase-alignment relationship. A second set acquisition module 530 may be utilized for obtaining a second set of aligned phrases of the current language phrases that align with selected phrases in the first set of aligned phrases according to the second phrase-alignment relationship. A synonymous phrase acquisition module 540 may be utilized for obtaining the synonymous phrases of the target phrase from the second aligned phrase set.

More specifically, the alignment relationship obtaining module 510 may further include: a word-aligning relationship acquisition sub-module for obtaining the word-aligning relationship between a current language word and an intermediate language word in each parallel sentence pair of the parallel text corpus; a phrase pair extracting sub-module for extracting an aligned phrase pair according to the word-aligning relationship; a first alignment relationship acquisition sub-module for obtaining, with respect to the current language phrases for each phrase pair, all intermediate language phrases that align with the current language phrase according to the extracted phrase pair, and thereby obtaining a first phrase-alignment relationship that is from the current language phrase to the intermediate language phrase; and a second alignment relationship obtaining sub-module for obtaining, with respect to the intermediate language phrases for each phrase pair, all current language phrases that align with the intermediate language phrase according to the extracted phrase pair, and thereby obtaining a first phrase-alignment relationship that is from the intermediate language phrase to the current language phrase.

The first set acquisition module 520 may further include a first selecting sub-module for selecting the intermediate language phrases that are aligned with the target phrase according to the degree of semantic similarity between each intermediate language phrase and the target phrases in the first phrase-alignment relationship, and thereby forming a first set of aligned phrases.

The second set acquisition module 530 may further include a second selecting sub-module for selecting the current language phrases that are aligned with the selected phrases in the first set of aligned phrases according to the degree of semantic similarity between each current language phrase and the selected phrases in the first set of aligned phrases in the second phrase-alignment relationship, and thereby forming a second set of aligned phrases.

The synonymous phrase acquisition module 540 may further include a third selecting sub-module for selecting synonymous phrases of the target phrase according to the degree of semantic similarity between each phrase in the second set of aligned phrases and the target phrase.

According to another embodiment of the present disclosure, the apparatus 500 may include a repeating module (not shown) for: repeating blocks (b) to (d) by taking one or more phrases selected from the synonymous phrases as the target phrases of the current language respectively, and thereby obtaining the synonymous phrases of the one or more phrases selected from the synonymous phrases; and taking the selected synonymous phrases and the obtained one or more phrases of the selected synonymous phrase as the synonymous phrases of the target phrases together.

According to another embodiment of the present disclosure, the apparatus 500 may include a filtering module (not shown) for filtering the synonymous phrases of the target phrases according to a predetermined rule.

Specifically, the predetermined rule comprises at least one of the following:

determining whether the synonymous phrases include a word in a disabled words list;

determining whether synonymous phrases include a word in a prohibited words list;

determining whether the synonymous phrases include a punctuation mark;

determining whether there is a covering relationship between the synonymous phrase and the target phrase; and

determining whether any of two phrases in the synonymous phrases are identical after their phrase roots are extracted.

Since the functionality of the apparatus in this embodiment is basically corresponding to the method in the above embodiments as shown in FIG. 1, thus the detail of this embodiment can be obtained by referring to the descriptions of the aforementioned embodiments, and will be omitted here.

Similar to the aforementioned method for mining synonymous phrases, the apparatus for mining synonymous phrases provided by the present disclosure is able to obtain an enormous amount of accurate synonymous phrases.

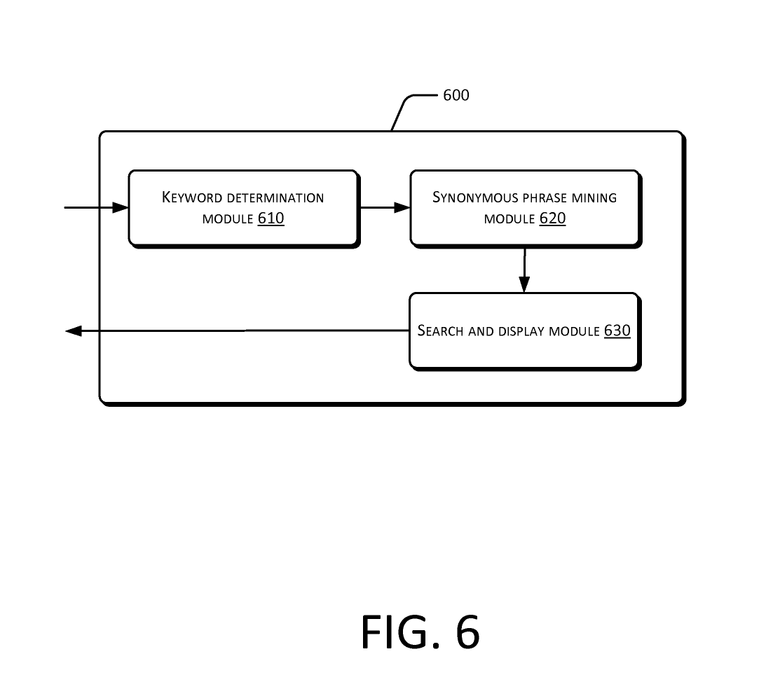

FIG. 6 is a block diagram illustrating an apparatus 600 for searching relevant content based on an inquiry of a user according to one embodiment of the present disclosure.

As shown in FIG. 6, the apparatus 600 may include a keyword determination module 610, a synonymous phrase mining module 620 and a search and display module 630.

Specifically, a keyword determination module 610 may be used to determine searching keywords according to the received inquiry. The synonymous phrase mining module 620 may be used to obtain synonymous phrases of the searching keywords according to the method as shown in FIG. 1. The search and display module 630 may be used to search and display the relevant content according to the searching keywords and the synonymous phrases of the searching keywords.

Since the functionality of the apparatus in this embodiment is basically corresponding to the method in the above embodiments as described in FIG. 4, the detail of this embodiment can be obtained by referring to the descriptions of the aforementioned embodiments, and will be omitted here.

Similar to the above method for searching relevant contents according to an inquiry request, the apparatus for searching the relevant content based on an inquiry is able to expand search coverage for the user's needs, and increase the likelihood and comprehensiveness of coverage in terms of the user's desired content. The search performance is therefore enhanced, capable of providing the user with information that he/she wishes to retrieve and facilitating user utilization.

A person with an ordinary skill in the art should understand that the embodiment of the present disclosure can be provided as a method, a system or a product of a computer program. Therefore, the present disclosure can be implemented as an embodiment of only hardware, an embodiment of only software or an embodiment of a combination of hardware and software. Moreover, the present disclosure can be implemented as a product of a computer program that can be stored in a computer readable storage medium (which includes but is not limited to: a disk memory, a CD-ROM, an optical memory, etc.).

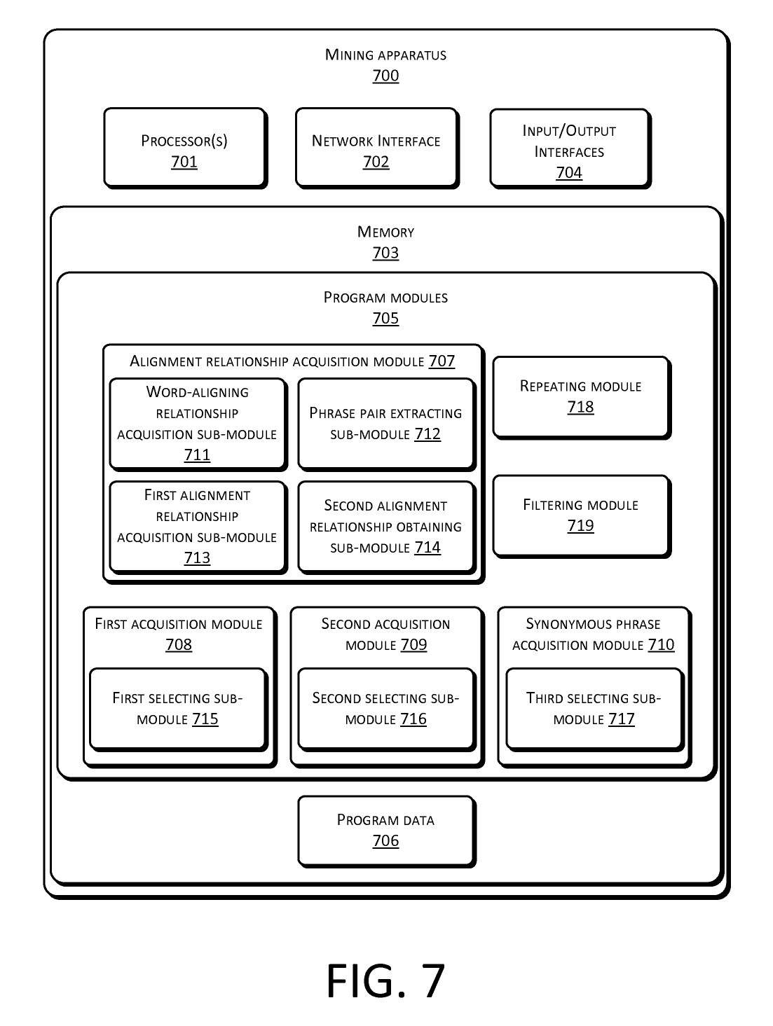

In a practical implementation of the present disclosure, a computing device includes one or more processors (CPU), input/output interfaces, network interfaces and memory. For example, FIG. 7 illustrates an example mining apparatus 700, such as the apparatus as described in FIG. 5, in more detail. In one embodiment, the mining apparatus 700 can include, but is not limited to, one or more processors 701, a network interface 702, memory 703, and an input/output interface 704.

The memory 703 may include non-permanent memory, a random access memory (RAM) and/or a nonvolatile memory, e.g., a read-only memory (ROM) or a flash memory (flash RAM) as used in a computer readable medium. The memory 703 can be regarded as an example of a computer readable medium.

A computer readable medium includes permanent and non-permanent as well as removable and non-removable media capable of accomplishing a purpose of information storage by any method or technique. The information may be referred to a computer readable instruction, a data structure, a program module or other data. Examples of a computer storage medium include, but are not limited to: a phase-change memory (PRAM), a static random-access memory (SRAM), a dynamic random access memory (DRAM), other types of random access memory (RAM), a read-only memory (ROM), an electrically-erasable programmable read-only memory (EEPROM), a flash memory or other memory technologies, a compact disc read-only memory (CD-ROM), a digital versatile disk (DVD) or other optical storage media, a cassette tape, a diskette or other magnetic storage device, or any other non-transmission medium which can be used to store information that is accessible by a computing device. According to the definition of the present disclosure, the computer readable medium does not include non-transitory media such as a modulated data signal and a carrier wave.

The memory 703 may include program modules 705 and program data 706. In one embodiment, the program modules 705 may include an alignment relationship acquisition module 707, a first acquisition module 708, a second acquisition module 709, a synonymous phrase acquisition module 710, a word-aligning relationship acquisition sub-module 711, a phrase pair extracting sub-module 712, a first alignment relationship acquisition sub-module 713, a second alignment relationship obtaining sub-module 714, a first selecting sub-module 715, a second selecting sub-module 716, a third selecting sub-module 717, a repeating module 718 and a filtering module 719. Details about these program modules and sub-modules may be found in the foregoing embodiments described above.

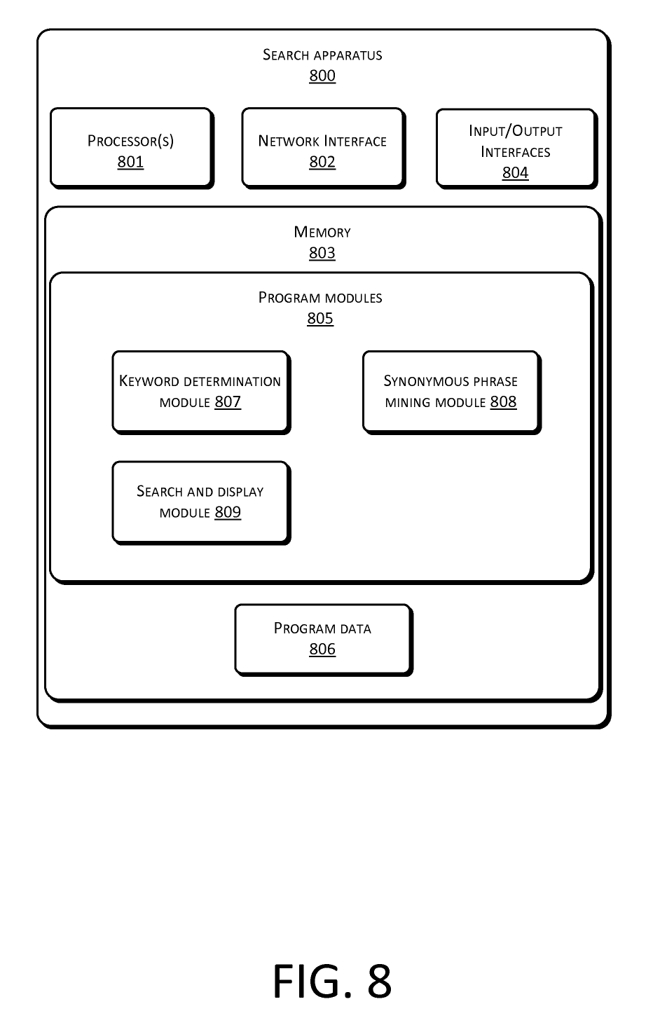

FIG. 8 illustrates an example search apparatus 800, such as the apparatus as described in FIG. 6, in more detail. In one embodiment, the search apparatus 800 can include, but is not limited to, one or more processors 801, a network interface 802, memory 803, and an input/output interface 804. The memory 803 may include computer-readable media in the form of volatile memory, such as random-access memory (RAM) and/or non-volatile memory, such as read only memory (ROM) or flash RAM. The memory 803 is an example of computer-readable media.

The memory 803 may include program modules 805 and program data 806. In one embodiment, the program modules 805 may include a keyword determination module 807, a synonymous phrase mining module 808 and a search and display module 809. In one embodiment, the search apparatus 800 may include the mining apparatus 700. In other embodiments, the search apparatus 800 may be communicatively connected to the mining apparatus 700 via a network. The network may include be a wireless or a wired network, or a combination thereof. The network may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof. Wired networks may include an electrical carrier connection (such a communication cable, etc.) and/or an optical carrier or connection (such as an optical fiber connection, etc.). Wireless networks may include, for example, a WiFi network, other radio frequency networks (e.g., Bluetooth®, Zigbee, etc.), etc. Details about these program modules may be found in the foregoing embodiments described above.

The embodiments described above are only exemplary embodiments of the present disclosure, and not intended to limit the scope of the present disclosure. Various modifications and alternations can be made to the present disclosure by a person of ordinary skill in the art. Any modifications, replacements and improvements should fall within the spirit and the scope of the present disclosure.

What is claimed is:

1. A computer-implemented method for mining synonymous phrases, comprising:
obtaining, according to a parallel text corpus, a first phrase-alignment relationship from current language phrases to intermediate language phrases, and a second phrase-alignment relationship from the intermediate language phrases to the current language phrases;
obtaining, with respect to a target phrase of current language, a first set of aligned phrases of the intermediate language that are aligned with the target phrase based on the first phrase-alignment relationship;
obtaining a second set of aligned phrases of the current language that are aligned with one or more selected phrases in the first set of aligned phrases based on the second phrase-alignment relationship; and
obtaining synonymous phrases for the target phrase from the second set of aligned phrases.

2. The method of claim 1, wherein obtaining the first phrase-alignment relationship further comprises:
obtaining a word-aligning relationship between current language words and intermediate language words in each parallel sentence pair of the parallel text corpus;
extracting aligned phrase pairs based on the word-aligning relationship;
obtaining, with respect to a current language phrase of each phrase pair, all intermediate language phrases that are aligned with the current language phrase based on the extracted phrase pairs, and thereby obtaining the first phrase-alignment relationship from the current language phrases to the intermediate language phrases; and
obtaining, with respect to an intermediate language phrase of each phrase pair, all current language phrases that are aligned with the intermediate language phrase based on the extracted phrase pairs, and thereby obtaining the second phrase alignment relationship from the intermediate language phrases to the intermediate language phrases.

3. The method of claim 1, wherein obtaining the first set of aligned phrases further comprises:
selecting the intermediate language phrases that are aligned with the target current language phrase based on a degree of semantic similarity between each intermediate language phrase and the target phrase in the first phrase-alignment relationship to form the first set of aligned phrases.

4. The method of claim 1, where obtaining the second set of aligned phrases further comprises:
selecting the current language phrases that are aligned with the selected phrase in the first set of aligned phrases based on a degree of semantic similarity between each current language phrase and the selected phrase in the first phrase-alignment relationship to form the second set of aligned phrases.

5. The method of claim 1, wherein obtaining the synonymous phrases further comprises:
selecting the synonymous phrases of the target phrase based on a degree of semantic similarity between each phrase in the second set of aligned phrases and the target phrase.

6. The method of claim 1, further comprising:
repeating the obtaining of the first set of aligned phrases, the obtaining of the second set of aligned phrases and the obtaining of the synonymous phrases for one or more phrases selected from the synonymous phrases that are taken as target phrases of the current language respectively, and thereby obtaining synonymous phrases of the one or more phrases selected from the synonymous phrases;
taking the selected synonymous phrases and the obtained synonymous phrases of the one or more selected phrases of the synonymous phrases as the synonymous phrases of the target phrases.

7. The method of claim 1, further comprising:
filtering the synonymous phrases of the target phrase according to a predetermined rule.

8. The method of claim 7, wherein the predetermined rule comprises at least one of:
determining whether a synonymous phrase includes a word in a disabled words list;
determining whether the synonymous phrase includes a word in a prohibited words list;
determining whether the synonymous phrase includes a punctuation mark;
determining whether there is a covering relationship between the synonymous phrase and the target phrase; and
determining whether any of two phrases in the synonymous phrases are identical after a phrase root thereof is extracted.

9. The method of claim 1, further comprising:
determining a search keyword based on a received search request;
obtaining a synonymous phrase of the search keyword with the search keyword being taken as the target phrase; and
searching and displaying relevant content based on the search keyword and the synonymous phrase of the search keyword.

10. An apparatus of mining synonymous phrases, comprising:
an alignment relationship acquisition module used for obtaining, according to a parallel text corpus, a first phrase-alignment relationship from phrases of a current language to phrases of an intermediate language, and a second phrase-alignment relationship from the phrases of the intermediate language to the phrases of the current language;
a first set acquisition module used for obtaining, with respect to a target phrase of the current language, a first set of aligned phrases of the intermediate language that are aligned with the target phrase of the current language based on the first phrase-alignment relationship;
a second set acquisition module used for obtaining a second set of aligned phrases of the current language that are aligned with selected phrase(s) in the first set of aligned phrases based on the second phrase-alignment relationship; and
a synonymous phrase acquisition module used for obtaining synonymous phrases of the target phrase from the second set of aligned phrases.

11. The apparatus of claim 10, wherein the alignment relationship acquisition module further comprises:
a word-aligning relationship acquisition sub-module used for obtaining a word-aligning relationship between words of the current language and words of the intermediate language in each parallel sentence pair of the parallel text corpus;
a phrase pair extracting sub-module used for extracting aligned phrase pairs based on the word-aligning relationship;
a first alignment relationship acquisition sub-module used for obtaining, for a phrase of the current language in each phrase pair, all phrases of the intermediate language that are aligned with the phrase of the current language based on the extracted phrase pairs, and thereby obtaining the first phrase-alignment relationship from the phrases of the current language to the phrases of the intermediate language; and
a second alignment relationship acquisition sub-module used for obtaining, for a phrase of the intermediate language in each phrase pair, all phrases of the current language that are aligned with the phrase of the intermediate language based on the extracted phrase pairs, and thereby obtaining the second phrase-alignment relationship from the phrases of the intermediate language to the phrases of the current language.

12. The apparatus of claim 10, wherein the first set acquisition module further comprises:
a first selecting sub-module used for selecting the phrases of the intermediate language that are aligned with the target phrase based on a degree of semantic similarity between each phrase of the intermediate language and the target phrase in the first phrase-alignment relationship to form the first set of aligned phrases.

13. The apparatus of claim 10, wherein the second set acquisition module further comprises:
a second selecting sub-module used for selecting the phrases of the current language that are aligned with the selected phrase(s) in the first set of aligned phrases based on degrees of semantic similarity between each phrase of the current language and the selected phrases in the first set of aligned phrases in the first phrase-alignment relationship to form the second set of aligned phrases.

14. The apparatus of claim 10, wherein the synonymous phrase acquisition module further comprises:
a third selecting sub-module used for selecting the synonymous phrases of the target phrase based on a degree of semantic similarity between each phrase in the second set of aligned phrases and the target phrase.

15. The apparatus of claim 10, further comprising a repeating module used for:
repeating the obtaining of the first set of aligned phrases, the obtaining of the second set of aligned phrases and the obtaining of the synonymous phrases for one or more phrases selected from the synonymous phrases that are taken as target phrases of the current language respectively, and thereby obtaining synonymous phrases of the one or more phrases selected from the synonymous phrases; and
taking the selected synonymous phrases and the obtained synonymous phrases of the one or more phrases of the synonymous phrases as the synonymous phrases of the target phrases.

16. The apparatus of claim 10, further comprising:
a filtering module used for filtering the synonymous phrases of the target phrase according to a predetermined rule.

17. The apparatus of claim 16, wherein the predetermined rule comprise at least one of:
determining whether a synonymous phrase includes a word in a disabled words list;
determining whether the synonymous phrase includes a word in a prohibited words list;
determining whether the synonymous phrase includes a punctuation mark;
determining whether there is a covering relationship between the synonymous phrase and the target phrase; and
determining whether any of two phrases in the synonymous phrases are identical after a phrase root thereof is extracted.

18. The apparatus of claim 10, further comprising:
a keyword determining module used for determining a search keyword based on a received search request;
a synonymous phrase mining module used for obtaining a synonymous phrase of the search keyword by taking the search keyword as the target phrase; and
a search and display module used for searching and displaying relevant content based on the search keyword and the synonymous phrase of the search keyword.

19. One or more computer-readable media storing executable instructions that, when executed by one or more processors, cause the one or more processors to perform acts comprising:
determining a search keyword of a current language based on a received search request;
obtaining a first set of aligned phrases of an intermediate language that are aligned with the search keyword based on a first phrase-alignment relationship from current language phrases to intermediate language phrases;
obtaining a second set of aligned phrases of the current language that are aligned with one or more selected phrases in the first set of aligned phrases based on a second phrase-alignment relationship from the intermediate language phrases to the current language phrases; and
obtaining one or more synonymous phrases for the search keyword from the second set of aligned phrases; and
searching and displaying related content based on the search keyword and the one or more synonymous phrases of the search keyword.

20. The one or more computer-readable media of claim 19, the acts further comprising filtering the one or more synonymous phrases of the search keyword according to a predetermined rule.
